(19) United States
(12) Patent Application Publication
(10) Pub. No.: US 2014/0000492 A1
(43) Pub. Date: Jan. 2, 2014

(54) Table Bag

(71) Applicant: Abel Tapia, Phoenix, AZ (US)

(72) Inventor: Abel Tapia, Phoenix, AZ (US)

(21) Appl. No.: 13/875,512

(22) Filed: May 2, 2013

Related U.S. Application Data
(60) Provisional application No. 61/687,807, filed on May 2, 2012.

(51) Int. Cl. A47G 11/00; B65F 1/00

(52) U.S. Cl. CPC A47G 11/003; B65F 1/0006
USPC 108/14

(57) ABSTRACT

The invention provides a tablecloth featuring a drawstring and additional fixtures. The Table Bag is a tablecloth capable of resisting wind pressure while making the cleanup process after a party much simpler. The Table Bag is a tablecloth featuring a drawstring on its underside allowing for the cloth to remain in place on a table and to double as a trash bag for cleanup after a party.

### CLAIM OF PRIORITY

This patent application claims priority under 35 USC 119 (e) (1) from U.S. Provisional Patent Application Ser. No. 61/687,807 filed May 02, 2012, of common inventorship herewith entitled, “Table Bag.”

### FIELD OF THE INVENTION

The present invention pertains to the field of party supplies, and more specifically to the field of functional party tablecloths.

### BACKGROUND OF THE INVENTION

The prior art has put forth several designs for tablecloths. Among these are:

U.S. Pat. No. 5,069,554 to George M. Bonnett describes a disposal system comprising a temporary disposal work surface covering of a substantially flat and flexible sheet material such as extruded plastic or the like, having cinch means incorporated therein. While the preferred embodiment of the present invention is exemplified as a disposable tablecloth, the invention is useful in a variety of applications including lawn care, garbage collection and any use which requires traditional garbage bags, but at a significant decrease in disposal effort and expense. An alternative embodiment of the invention teaches a tablecloth or the like having a upwardly extended peripherally surrounding raised edge areas for preventing liquids from spilling onto the users. Likewise, incorporated therein is a cinch strap system for enveloping the contained refuse. The lifted or raised edge may comprise merely a plastic ridge or preferably a multitude of accordion folds formed from the plastic sheeting forming the main centrally.

U.S. Pat. No. 5,339,748 to Alfred J. Bilotti describes a table cover for covering a table top. The table cover comprises a panel having a sleeve provided along its peripheral edge. The sleeve has an exposed section and a first opening and a second opening about the exposed section. A drawstring is held within the sleeve and has a first end extending from the first opening and a second end extending from the second opening. A tongue is coupled to the panel about the exposed section of the sleeve between the first opening and the second opening, with the tongue having a loop provided therethrough. The first end of the drawstring passes through the loop in a first direction and the second end of the drawstring passes through the loop in a second direction opposite the first direction to secure a taut fit of the table cover to the table top.

U.S. Pat. No. 6,014,935 to Timothy Willett describes an all weather outdoor table cover with a tablecloth for placement on a table and straps attached at the tablecloth perimeter to provide for securing to the table top. A protective cover is attached to a portion of the tablecloth perimeter and is constructed of a pliable material so it may be folded for storage when not in use. A hem is formed in the perimeter of the protective cover and has a draw cord contained therein which is accessible through two openings. When it is desired to cover the table and its contents, the protective cover is pulled over the table top and secured under it by pulling on the draw cords to pull the protective cover under the table top. This will protect the tablecloth and contents from weather, pests and the like. Storage pockets may also be attached to the perimeter of the tablecloth.

None of these prior art references describe the present invention.

### SUMMARY OF THE INVENTION

It is an object of the present invention to provide a party tablecloth with a drawstring for security and conversion to a trash bag.

### BRIEF DESCRIPTION OF THE DRAWINGS

FIG. 1 is a functional diagonal top view of the present invention placed on a table showing draped sides and balloon adhesive strips and ties.

FIG. 2 is functional diagonal top view showing the present invention used as a trash bag when finished.

FIG. 3 is a perspective diagonal underside view showing a drape edge and an inside draw string encompassing the underneath side of the present invention.

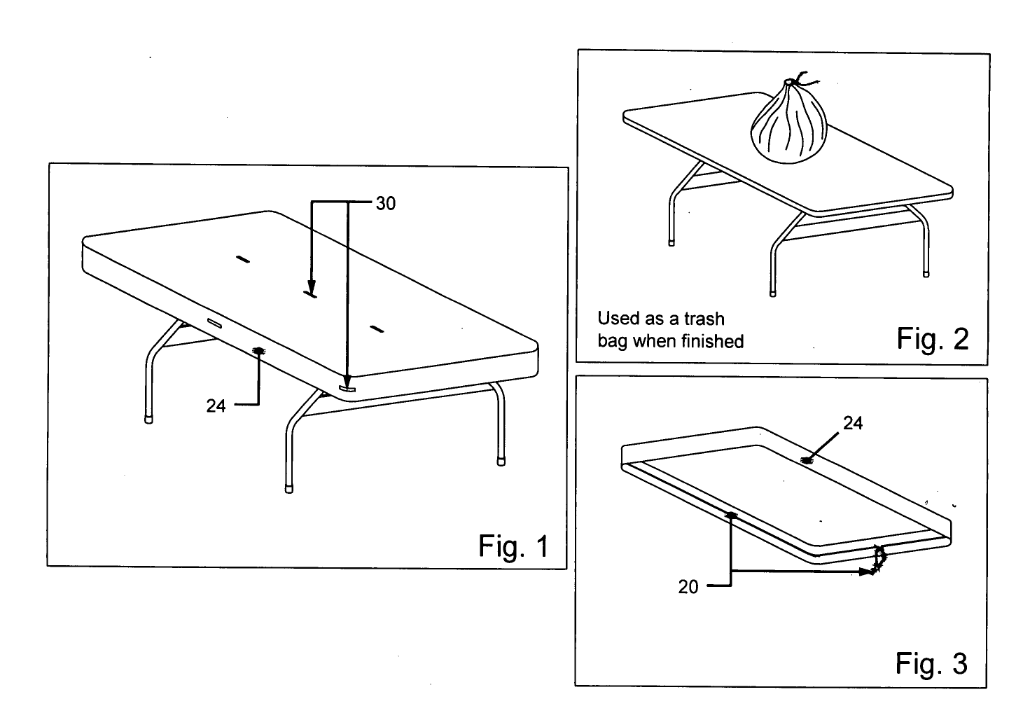

### DETAILED DESCRIPTION OF THE INVENTION

When organizing a party, whether it be a birthday party for a child or an anniversary party for friends, all the items essential to making that party an unforgettable one is a long list. A party planner spends a great deal of time picking out the perfect cake, presents, dishes, balloons, music, and other party items. One party item that is necessary in completing any celebration setup is a tablecloth. A tablecloth is perhaps the key to completing a perfect look of a party design. Imagine having a child's favorite cartoon character emblazoned on a blue backdrop of all of his party plates, presents, napkins, and party hats. Imagine that the cake also has hints of blue coloring with the same character iced on the top. So the party planner searches for a tablecloth to match the blue color scheme or party theme. That completed set of hats, presents, plates, and wrappings appear drab on a dull wooden picnic table. Immediately, the aesthetic value of the party setup goes downhill. Table clothes are essential for almost any party, especially outdoor parties.

The problem with tablecloths is that when the slightest wind kicks up, the cloth beats around carelessly in the wind. Especially frustrating is when a number of guests are trying to eat or enjoy the unwrapping of presents and the tablecloth keeps flapping in the way. Even worse is when the table has nothing heavy on top and the tablecloth flies off the table taking a well arranged party setup with it. If guests survive the length of the party without any mishaps, the host still is left with a mess of paper cups, plates and plastic ware to clean up afterward. This cleanup process usually involves carrying around a large trash bag or barrel and sliding all the aforementioned objects into it. This method is extremely tedious especially if multiple tables are set up at the party.

The present invention, hereinafter referred to as the Table Bag, is a uniquely designed tablecloth featuring a drawstring and additional fixtures. The Table Bag is a tablecloth capable of resisting wind pressure while making the cleanup process after a party much simpler. The Table Bag is a tablecloth featuring a drawstring 20 on its underside allowing for the cloth to remain in place on a table and to double as a trash bag for cleanup after a party. The drawstring 20 is shown in FIG. 3. The present invention resembles a normal tablecloth and can be sized to accommodate any table. One example of the tablecloth of the present invention measures approximately seven feet in length by three feet in width. On the underside of the Table Bag drawstring 20 encompassing the shape of the tablecloth allowing for a secure fit when attached to a table top. This drawstring 20 is integrally sewn into a casing on the underneath side of the tablecloth near the perimeter of the tablecloth and when tightened, the drawstring is hidden by tablecloth material draping down over the sides of a table creating drape 24. The tablecloth can be made of disposable material.

In an alternative embodiment, the drawstring runs along the perimeter of the tablecloth at the edge of the tablecloth. This drawstring also allows users to secure disposable items on the table after use thereby using the tablecloth as a trash bag.

The Table Bag contains a number of adhesive fixtures 30 along its center line or along its sides for attaching streamers, or one or more balloons. Consumers simply lay the Table Bag on a table like a normal tablecloth and adjust the drawstring tightly enough to make sure the table cloth is secured and will be unimpeded by motion and wind. Once the party or meal is over, users loosen the drawstring and fold the Table Bag upwards with trash and disposable items within it. This is shown in FIG. 2. A user then ties the top of the bag securely and disposes it. The Table Bag is available in a variety of other shapes, sizes, colors and designs to match the aesthetic needs of any party or consumer.

With an adjustable drawstring, party guests no longer are buffeted by tablecloth corners while eating or sitting down and no longer have to worry about the tablecloth and items on top of it blowing away because of wind gusts. Available in an assortment of colors and designs, consumers will pick out a Table Bag for practically any occasion including birthday parties, anniversary parties, weddings and family reunions. Ideal for personal use, catering companies find the Table Bag useful as it makes the setup and cleanup processes much simpler for these companies. A cleverly designed and convenient tablecloth capable of remaining in place on a table and doubling as a trash bag, the Table Bag will have an enthusiastic reception from a variety of individuals and companies.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A party tablecloth with a drawstring for security and conversion to a trash bag, comprising:
a tablecloth capable of resisting wind pressure further comprising a drawstring running near the perimeter on the underside of the table cloth to secure the tablecloth in place on a table and to permit the tablecloth to be gathered near its perimeter to secure disposable items, functioning as a trash bag for cleanup after use.

2. The party tablecloth with a drawstring of claim 1, further comprising a multiplicity of adhesive fixtures for attaching streamers and one or more balloons.

3. The party tablecloth with a drawstring of claim 2 wherein the multiplicity of adhesive fixtures are spaced apart and placed along the center line of the table cloth.

4. The party tablecloth with a drawstring of claim 2 wherein the multiplicity of adhesive fixtures are spaced apart and placed near the edge of the tablecloth.

5. The party tablecloth with a drawstring of claim 1, sized to accommodate any table.

6. The party tablecloth with a drawstring of claim 5, wherein the tablecloth measures approximately seven feet in length by three feet in width.

7. The party tablecloth with a drawstring of claim 1, wherein the drawstring is integrally attached into a casing in the underneath side of the tablecloth and when tightened, the drawstring is hidden by tablecloth material draping down over the sides of a table creating a drape.

8. The party tablecloth with a drawstring of claim 1, wherein the tablecloth is disposable.

9. A party tablecloth with a drawstring for security and conversion to a trash bag, comprising:
a tablecloth capable of resisting wind pressure further comprising a drawstring running along the perimeter on the underside of the table cloth to secure the tablecloth in place on a table and to permit the tablecloth to be gathered near its perimeter to secure disposable items, functioning as a trash bag for cleanup after use.

10. The party tablecloth with a drawstring of claim 9, further comprising a multiplicity of adhesive fixtures for attaching streamers and one or more balloons.

11. The party tablecloth with a drawstring of claim 9 wherein the multiplicity of adhesive fixtures are spaced apart and placed along the center line of the table cloth.

12. The party tablecloth with a drawstring of claim 9 wherein the multiplicity of adhesive fixtures are spaced apart and placed near the edge of the tablecloth.

13. The party tablecloth with a drawstring of claim 9, sized to accommodate any table.

14. The party tablecloth with a drawstring of claim 13, wherein the tablecloth measures approximately seven feet in length by three feet in width.
